(19) United States
(12) Patent Application Publication
(10) Pub. No.: US 2013/0224551 A1
(43) Pub. Date: Aug. 29, 2013

(54) Apparatus and Associated Methods

(71) Applicants: Pritesh HIRALAL, Las Palmas (ES); Samiul Haque, Cambridge (GB); Darryl Cotton, St. Ives (GB); Chris Bower, Ely (GB)

(72) Inventors: Pritesh HIRALAL, Las Palmas (ES); Samiul Haque, Cambridge (GB); Darryl Cotton, St. Ives (GB); Chris Bower, Ely (GB)

(73) Assignee: Nokia Corporation

(21) Appl. No.: 13/408,206

(22) Filed: Feb. 29, 2012

(51) Int. Cl. H01M 10/02; H01G 9/10; H01M 10/04; B82Y 99/00

(52) U.S. Cl. 429/127; 29/623.2; 361/518; 977/948

(57) ABSTRACT

An apparatus including at least one substrate, the at least one substrate including first and second electrodes and configured to form a sealed chamber with the first and second electrodes contained therein and facing one another, the sealed chamber including electrolyte in the space between the first and second electrodes, wherein the at least one substrate is configured to undergo reversible stretching whilst still forming the sealed chamber containing the electrolyte.

### TECHNICAL FIELD

The present disclosure relates to the field of flexible/stretchable electronics, associated methods and apparatus, and in particular concerns a stretchable energy storage cell which may be suitable for use in wearable electronics. Certain disclosed example aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Wearable (or conformable) electronics is an emerging field of technology in which electronic devices are embedded in clothing (e.g. smart textiles). In order to retain the comfort of the clothing, such devices should be soft, flexible and to a certain degree stretchable. The majority of energy storage technologies in existence today, however, are in the form of bulk, solid pieces. Although thin-film flexible batteries exist, the flexibility of these devices is relatively limited due to delamination of the electrode materials. In addition, none of the currently available flexible cells are stretchable.

The apparatus and methods disclosed herein may or may not address this issue.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus comprising at least one substrate, the at least one substrate comprising first and second electrodes and configured to form a sealed chamber with the first and second electrodes contained therein and facing one another, the sealed chamber comprising electrolyte in the space between the first and second electrodes, wherein the at least one substrate is configured to undergo reversible stretching whilst still forming the sealed chamber containing the electrolyte.

The apparatus may be configured for the generation (e.g. via redox reactions or an intercalation mechanism) and/or storage (e.g. via charge separation) of electrical energy.

The apparatus may comprise first and second substrates. The first substrate may comprise the first electrode and the second substrate may comprise the second electrode. The first and second substrates may be joined together to form the sealed chamber. The first and/or second substrate may be configured to undergo reversible stretching.

The apparatus may comprise a first substrate. The first substrate may comprise both the first and second electrodes. The first substrate may be bent around onto itself to form the sealed chamber.

The apparatus may be configured such that the first electrode is able to move laterally with respect to the second electrode when the at least one substrate undergoes reversible stretching.

The at least one substrate may comprise a thermoplastic elastomer (stretchable thermoplastic). The thermoplastic elastomer may comprise one or more of a thermoplastic urethane (polyester-based, polyether-based, or polycapa-based); a styrene-based thermoplastic elastomer (e.g. styrene-ethylene-butadiene-styrene (SEBS), styrene-butadiene-styrene (SBS), styrene-isoprene-styrene (SIS), or styrene-ethylene-propylene-styrene (SEPS)); a polyamide-based thermoplastic elastomer (e.g. ester-ether-amide (PEEA), ester-amide (PEA), carbonate-ester-amide (PCEA), or ether-block-amide (PEBA)); a polyester-based thermoplastic elastomer (e.g. ester-ether (PEE)); a polyolefin-based thermoplastic elastomer (e.g. polypropylene or ethylene and vulcanised rubber (PP+EPDM), or polypropylene or ethylene and vulcanised/non-vulcanised rubber); a polymeric organosilicon (e.g. polydimethylsiloxane (PDMS)); a fluoropolymer (e.g. polytetrafluoroethylene (PTFE)); and a thermoplastic urethane with dynamically vulcanised silicone.

The first and/or second electrode may comprise an active material. The term “active material” may be taken to mean the electrode material which takes part in the charging/discharging mechanism of the apparatus. In a battery, for example, the active material may be an electrode material which participates in an electrochemical reaction or intercalation mechanism. In a supercapacitor, on the other hand, the active material may be an electrode material which participates in the formation of an electric double layer.

The active material may comprise one or more of the following: carbon nanoparticles, carbon nanotubes, carbon nanohorns, a carbon nanotube network, graphene, graphene platelets, metal nanowires, a metal nanowire mesh, semiconductor nanowires, a semiconductor nanowire mesh, and metal oxide nanoparticles. The carbon nanotubes may be substantially horizontally-aligned on the at least one substrate. Where the active material is for use in a battery, the active material may comprise LiCoO₂, LiFeO₂, Li metal, and graphite (preferably in a fibrous form). The active material may be optically transparent.

The first and/or second electrode may comprise a charge collection material. The charge collection material may comprise one or more of an electrically conductive textile, a layer of metal, a layer of metal meanders, and a plurality of metal particles. The electrically conductive textile may comprise electrolycra. The metal may comprise gold, aluminium, copper and/or silver.

The first and/or second electrode may comprise an electrical connector. The electrical connector may comprise metal tape and/or a metal meander. The metal may comprise gold, aluminium, copper and/or silver.

The apparatus may comprise a separator between the first and second electrodes. The separator may comprise one of more of the following: cotton, polyester, lycra, a fluoroelastomer, a polyester elastomer, a hydrocarbon elastomer, or any other insulating, stretchable fibre. The electrolyte may be contained within the separator (i.e. the separator is soaked in the electrolyte).

The term “electrolyte” may encompass both an electrically insulating material (e.g. dielectric) as used in conventional electrostatic capacitors, as well as an ionically conducting material as used in electrolytic capacitors and supercapacitors. The electrolyte may be a liquid or gel electrolyte. The electrolyte may comprise propylene carbonate, an aqueous solution of potassium chloride, or any ionically conducting medium which is chemically resistant to the at least one substrate and the first and second electrodes.

One or more of the active material, the charge collection material, and the electrical connector may be located on and/or within the at least one substrate. The active material may be located on and/or within the charge collection material.

One or more of the at least one substrate, the active material, the charge collection material, the electrical connector, the separator, and the electrolyte may be configured to undergo reversible stretching and/or bending. One or more of the at least one substrate, the active material, the charge collection material, the electrical connector, the separator, and the electrolyte may be configured to undergo reversible stretching of up to 20%, 30%, 50%, or 100% tensile strain. One or more of the at least one substrate, the active material, the charge collection material, the electrical connector, the separator, and the electrolyte may be configured to undergo reversible bending to an angle of 45°, 90°, 135°, or 180°. One or more of the at least one substrate, the active material, the charge collection material, the electrical connector, the separator, and the electrolyte may be sufficiently flexible and/or stretchable to render the apparatus suitable for use in flex-to-install, stretch-to-install, dynamic stretch, and/or dynamic flex applications.

In an unstretched state, the apparatus may have a generally planar form. One or more of the at least one substrate, the active material, the charge collection material, the electrical connector, the separator, and the electrolyte may be configured to undergo reversible stretching substantially parallel to the plane of the apparatus. One or more of the at least one substrate, the active material, the charge collection material, the electrical connector, the separator, and the electrolyte may be configured to be reversibly bent about an axis substantially parallel to the plane of the apparatus.

The apparatus may be at least one of the following: a battery (primary or secondary battery), a capacitor (electrostatic, electrolytic, or supercapacitor), and a battery-capacitor hybrid.

According to a further aspect, there is provided a device comprising any apparatus described herein. The device may be at least one of the following: an electronic device, a portable electronic device, a portable telecommunications device, and a module for any of the aforementioned devices. The device may comprise a plurality of the above-mentioned batteries, capacitors, or battery-capacitor hybrids connected in series or in parallel.

According to a further aspect, there is provided a textile comprising any apparatus described herein. The textile may form part of an item of clothing.

According to a further aspect, there is provided a method of making an apparatus, the method comprising: providing at least one substrate; forming first and second electrodes on the at least one substrate; providing an electrolyte; and configuring the at least one substrate to form a sealed chamber with the first and second electrodes contained therein and facing one another, the sealed chamber comprising the electrolyte in the space between the first and second electrodes, wherein the at least one substrate is configured to undergo reversible stretching whilst still forming the sealed chamber containing the electrolyte.

Forming the first and/or second electrode may comprise providing a layer of substantially horizontally-aligned carbon nanotubes on the at least one substrate. The layer of substantially horizontally-aligned carbon nanotubes may be provided by: growing an array of substantially vertically-aligned carbon nanotubes on a growth substrate; compressing the carbon nanotubes between the growth substrate and the at least one substrate; and separating the growth substrate from the at least one substrate to produce a layer of substantially horizontally-aligned carbon nanotubes on the at least one substrate.

The expression “substantially horizontally-aligned” may be taken to mean that the long axes of the carbon nanotubes are aligned at an angle of 0°-20° with respect to the plane of the at least one substrate, and at an angle of 0°-20° with respect to one another (i.e. substantially flat and parallel).

The expression “substantially vertically-aligned” may be taken to mean that the long axes of the carbon nanotubes are aligned at an angle of 80°-100° with respect to the plane of the growth substrate, and at an angle of 0°-20° with respect to one another (i.e. substantially upright and parallel).

The steps of any method disclosed herein do not have to be performed in the exact order disclosed, unless explicitly stated or understood by the skilled person.

According to a further aspect, there is provided a computer program, recorded on a carrier, the computer program comprising computer code configured to perform any method described herein.

The apparatus may comprise a processor configured to process the code of the computer program. The processor may be a microprocessor, including an Application Specific Integrated Circuit (ASIC).

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described example embodiments.

The above summary is intended to be merely exemplary and non-limiting.

### BRIEF DESCRIPTION OF THE FIGURES

A description is now given, by way of example only, with reference to the accompanying drawings, in which:—

FIG. 1a illustrates schematically the discharge process of a conventional battery;

FIG. 1b illustrates schematically the charging process of a conventional battery;

FIG. 2a illustrates schematically the discharge process of a lithium-ion battery;

FIG. 2b illustrates schematically the charging process of a lithium-ion battery;

FIG. 3a illustrates schematically the charging process of a supercapacitor;

FIG. 3b illustrates schematically the discharge process of a supercapacitor;

FIG. 4a illustrates schematically the charging process of a lithium-ion capacitor;

FIG. 4b illustrates schematically the discharge process of a lithium-ion capacitor;

FIG. 5 illustrates schematically a reversibly stretchable battery;

FIG. 6 illustrates schematically a reversibly stretchable supercapacitor;

FIG. 7 illustrates schematically a reversibly stretchable storage cell comprising two substrates which are joined together to form a sealed chamber;

FIG. 8 illustrates schematically a reversibly stretchable storage cell comprising a single substrate which is bent around onto itself to form a sealed chamber;

FIG. 9 illustrates schematically a reversibly stretchable storage cell comprising a liquid electrolyte contained within a separator;

FIG. 10 illustrates schematically a reversibly stretchable storage cell comprising a charge collector at each electrode;

FIG. 11 illustrates schematically a reversibly stretchable storage cell comprising an electrical connector at each electrode;

FIG. 12 illustrates schematically a method of forming a layer of horizontally-aligned carbon nanotubes on the surface of a substrate;

FIG. 13 illustrates schematically different types of tensile stress that may be applied to a reversibly stretchable storage cell;

FIG. 14 illustrates schematically the extent to which a reversibly flexible storage cell may be bent about an axis parallel to the plane of the storage cell;

FIG. 15 illustrates photographically a reversibly stretchable storage cell under various magnitudes of tensile strain;

FIG. 16 illustrates graphically the variation in capacitance and equivalent series resistance for the reversibly stretchable storage cell of FIG. 15 at the different magnitudes of tensile strain;

FIG. 17 illustrates graphically the cyclic variation in capacitance and equivalent series resistance for the reversibly stretchable storage cell of FIG. 15 at 100% tensile strain;

FIG. 18a illustrates schematically a textile garment comprising a reversibly stretchable storage cell;

FIG. 18b illustrates schematically the textile garment of FIG. 18b in cross-section;

FIG. 19 illustrates schematically a device comprising a reversibly stretchable storage cell;

FIG. 20 illustrates schematically a method of making a reversibly stretchable storage cell;

FIG. 21 illustrates schematically a computer readable medium providing a program for controlling the making of a reversibly stretchable storage cell;

FIG. 22a illustrates schematically a stack of reversibly stretchable storage cells connected in series; and

FIG. 22b illustrates schematically a stack of reversibly stretchable storage cells connected in parallel.

### DESCRIPTION OF SPECIFIC ASPECTS/EMBODIMENTS

In electrical circuits, batteries and capacitors are used to provide other components with electrical power. These power supplies operate in completely different ways, however.

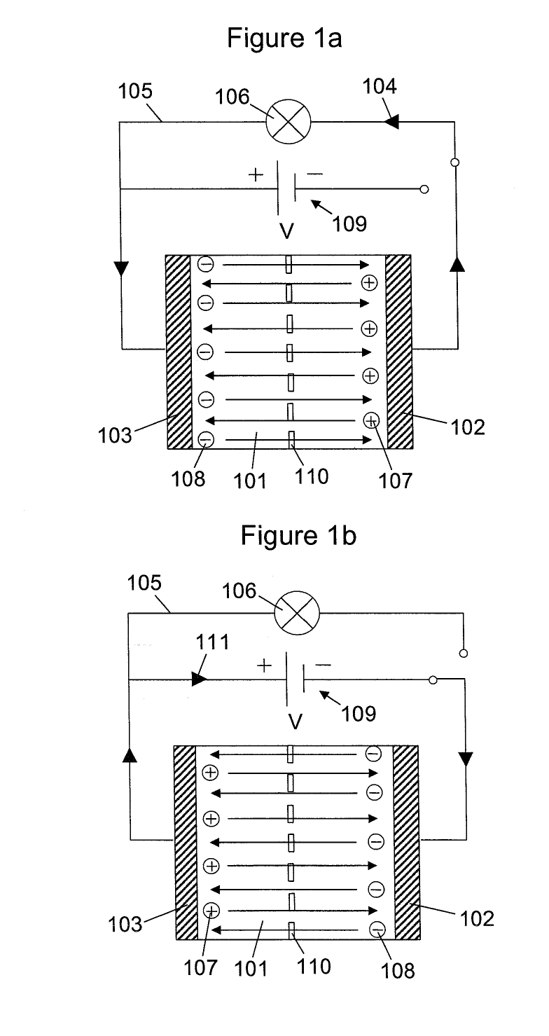

Batteries use electrochemical reactions to generate electricity. The discharge process of a conventional battery is shown in FIG. 1a. Batteries comprise two electrical terminals (electrodes 102, 103) separated by an electrolyte 101. A battery may also contain a separator 110 to prevent direct physical contact between the electrodes, which is particularly important when liquid electrolytes are used. At the negative electrode (the anode 102), an oxidation reaction takes place which produces electrons. These electrons flow round an external circuit 105 (indicated by the arrows 104) from the anode 102 to the positive electrode (the cathode 103) causing a reduction reaction to take place at the cathode 103. The flow of electrons can be used to power one or more electrical components 106 in the external circuit 105. The oxidation and reduction reactions may continue until the reactants are completely converted. Importantly though, unless electrons are able to flow from the anode 102 to the cathode 103 via the external circuit 105, the electrochemical reactions cannot take place. This allows batteries to store electricity for long periods of time. As the electrons flow round the external circuit from the anode 102 to the cathode 103, a negative charge cloud develops in the electrolyte 101 around the cathode 103, and a positive charge cloud develops in the electrolyte 101 around the anode 102. Positive 107 and negative 108 ions in the electrolyte 101 move to neutralise these charge clouds, allowing the reactions, and the flow of electrons, to continue. Without the ions 107, 108 from the electrolyte 101, the charge clouds around each electrode 102, 103 would inhibit the generation of electricity.

A primary cell is any kind of battery in which the electrochemical reaction is not reversible. These are used as disposable batteries. With secondary batteries, on the other hand, the electrochemical reaction is reversible, meaning that the chemical reactants can be restored to their original state. These are used as rechargeable batteries. The charging process of a conventional rechargeable battery is shown in FIG. 1b. To charge the battery, a potential difference is applied between the anode 102 and cathode 103. The positive terminal of the charger 109 strips electrons from the cathode 103 and returns them to the anode 102 (indicated by the arrows 111), inducing chemical reactions at the electrode-electrolyte interface. Again, to compensate for the transfer of charge, positive 107 and negative 108 ions in the electrolyte 101 move between the electrodes 102, 103 in opposite directions to before.

The current and voltage generated by a battery is directly related to the materials used for the electrodes and electrolyte. The ability of a material to lose or gain electrons with respect to another material is known as its electrode potential. The strengths of oxidising and reducing agents are indicated by their standard electrode potentials. Materials with a positive electrode potential are used to form the anode, whilst those with a negative electrode potential are used to form the cathode. The greater the difference between the anode and cathode potentials, the greater the amount of electrical energy that can be produced by the cell.

Lithium appears at the top of the electrochemical series (large negative electrode potential), indicating that it is the strongest reducing agent. Likewise, fluorine appears at the bottom of the electrochemical series (large positive electrode potential), indicating that it is the strongest oxidising agent. As a result of lithium's high electrode potential, lithium batteries are capable of producing voltages of nearly 4V, over twice the voltage of a zinc-carbon or alkaline battery. Depending on the choice of materials for the anode, cathode and electrolyte, the current, voltage, capacity, life and safety of a lithium battery can change dramatically. Recently, novel architectures have been employed to improve the performance of these batteries. Pure lithium is very reactive and will rigorously react with water to form lithium hydroxide and hydrogen gas. For this reason, non-aqueous electrolytes are used, and water is rigidly excluded from the battery pack using a sealed container.

That said, many different lithium batteries exist because of lithium's low reactivity with a number of cathodes and non-aqueous electrolytes. The term “lithium battery” refers to a family of different chemistries comprising lithium metal or lithium compounds as the anode with a host of different materials for the cathodes and electrolytes. A porous carbon material often serves as a cathode charge collector to receive electrons from the external circuit.

A lithium-ion battery is a different type of rechargeable battery which uses a lithium ion “intercalation” mechanism rather than traditional redox reactions. This involves the insertion of lithium ions into and out of the crystal structure of the electrodes as the ions pass back and forth between the electrodes during charging and discharging. To achieve this, the electrodes require open crystal structures which allow the insertion and extraction of lithium ions, and the ability to accept compensating electrons at the same time. Such electrodes are called “intercalation hosts”. Lithium-ion batteries are currently one of the most popular types of battery for portable electronics because they exhibit one of the best energy-to-weight ratios, no memory effect, a slow loss of charge when not in use. Furthermore, because lithium-ion batteries comprise a lithium compound electrode rather than a lithium metal electrode (which is highly reactive), they are inherently safer than lithium metal batteries.

In a typical lithium-ion battery, the anode is made from carbon, the cathode is a metal oxide, and the electrolyte is a lithium salt in an organic solvent. Commercially, the most popular anode material is graphite, and the cathode is generally one of three materials: a layered oxide (such as lithium cobalt oxide), one based on a polyanion (such as lithium iron phosphate), or a spinel (such as lithium manganese oxide). The electrolyte is typically a mixture of organic carbonates such as ethylene carbonate or diethyl carbonate containing complexes of lithium ions. These non-aqueous electrolytes often comprise non-coordinating anion salts such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃).

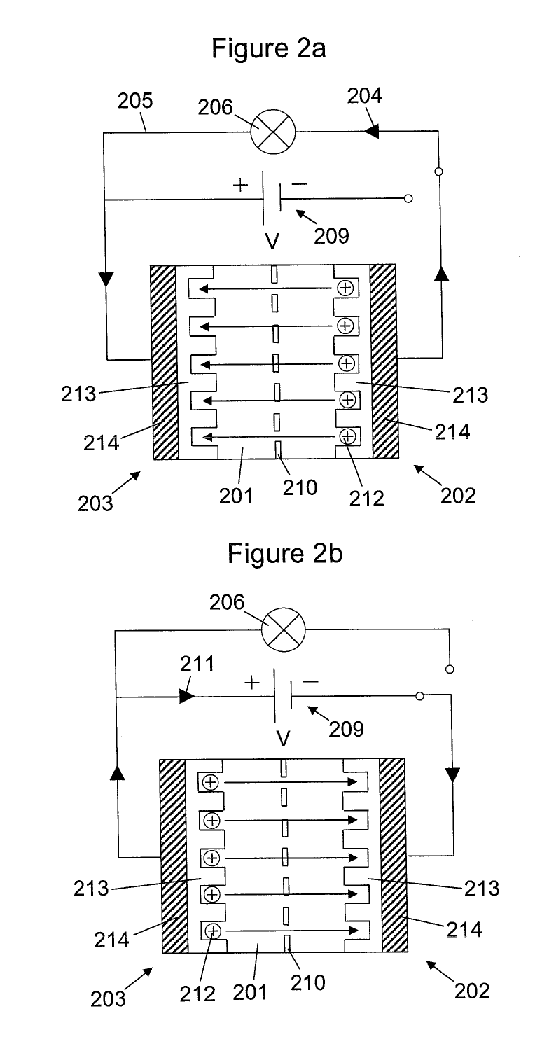

FIGS. 2a and 2b illustrate schematically the discharge and charging processes of a lithium-ion battery, respectively. As shown in the figures, the anode 202 and cathode 203 each comprise an open-crystal intercalation material 213 deposited on top of a charge-collecting substrate 214. During discharge, lithium ions 212 are extracted from the anode 202, migrate across the electrolyte 201, and are inserted into the crystal structure of the cathode 203. At the same time, compensating electrons travel in the external circuit (in a direction indicated by the arrows 204) and are accepted by the cathode 203 to balance the reaction. This process is reversible. During charging, an external electrical power source (the charger 209) applies a potential difference between the electrodes 202, 203 forcing the electrons to travel in the opposite direction (indicated by the arrows 211). The lithium ions 212 are then extracted from the cathode 203, migrate across the electrolyte 201, and are inserted back into the crystal structure of the anode 202.

In a lithium-ion battery, the lithium ions are transported to and from the cathode and anode, with the transition metal, cobalt (Co), in LiₓCoO₂ being oxidised from Co³⁺ to Co⁴⁺ during charging, and reduced from Co⁴⁺ to Co³⁺ during discharge. The anode and cathode half-reactions for a lithium-ion battery comprising a graphite anode and a lithium cobalt oxide cathode are as follows:

Anode xLi⁺+xe⁻+6C⇄LiₓC₆ Equation 1

Cathode LiCoO₂⇄Li₁₋ₓCoO₂+xLi⁺+xe⁻ Equation 2

The overall reaction has its limits, however. Overdischarging the lithium-ion battery can supersaturate the lithium cobalt oxide, leading to the production of lithium oxide, by the following irreversible reaction:

Li⁺+LiCoO₂→Li₂O+CoO Equation 3

whilst overcharging the lithium-ion battery can lead to the synthesis of Co⁴⁺ by the following irreversible reaction:

LiCoO₂→Li⁺+CoO₂ Equation 4

In contrast to batteries, capacitors store charge electrostatically, and are not capable of generating electricity. A relatively new type of capacitor known as a “supercapacitor” (also known as an electric double layer capacitor, an ultracapacitor, a pseudocapacitor, and an electrochemical double layer capacitor) offers greater energy storage than a conventional or electrolytic capacitor, and is becoming increasingly popular for portable electronic applications.

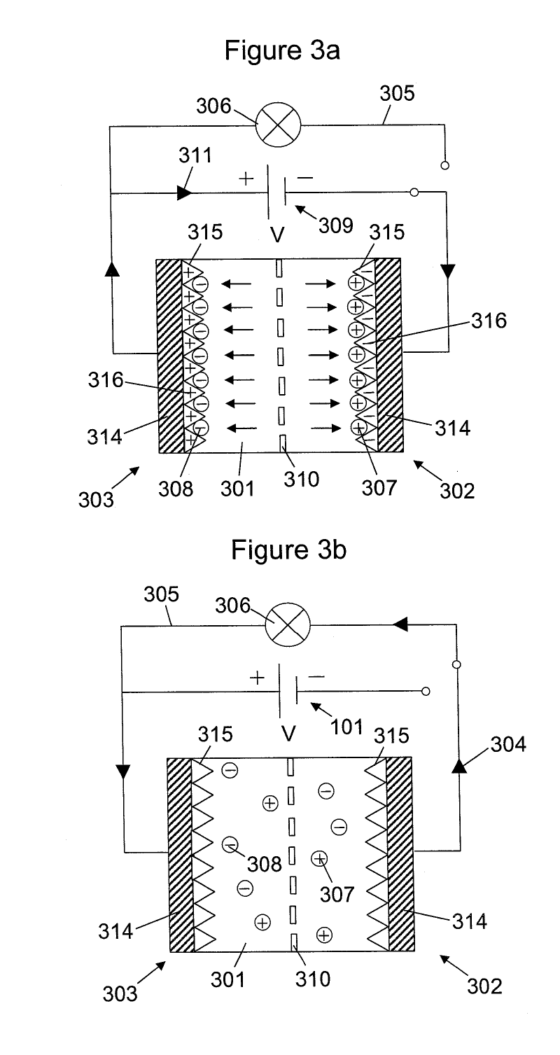

FIGS. 3a and 3b illustrate schematically the charging and discharge processes of a supercapacitor, respectively. Supercapacitors have a cathode 303 and an anode 302, each comprising an electrically conducting plate 314 (charge collector), which are separated by an electrolyte 301. When a liquid electrolyte is used, the supercapacitor may also comprise a separator 310 to prevent direct physical contact between the cathode and anode. The plates 314 are coated in a porous material 315 (such as powdered carbon) to increase their surface area for greater charge storage. When a power supply (charger) applies a potential difference between the electrodes 302, 303, the electrolyte 301 becomes polarised. The potential on the cathode 303 attracts negative ions 308 in the electrolye 301, and the potential on the anode 302 attracts positive ions 307.

Unlike batteries, the applied potential is kept below the breakdown voltage of the electrolyte 301 to prevent electrochemical reactions from taking place at the surface of the electrodes 302, 303. For this reason, supercapacitors cannot generate electricity like electrochemical cells. Also, without electrochemical reactions taking place, no electrons are generated. As a result, no significant current can flow between the electrolyte 301 and the electrodes 302, 303. Instead, the ions 307, 308 in solution arrange themselves at the surfaces of the electrodes 302, 303 to mirror the surface charge 316 and form an insulating “electric double layer”. In an electric double layer (i.e. a layer of surface charge 316 and a layer of ions 307, 308), the separation of the surface charge 316 and ions 307, 308 is on the order of nanometers. The combination of the electric double layer and the use of a high surface area material 315 on the surface of the plates 314 allow a huge number of charge carriers to be stored at the electrode-electrolyte interface.

To discharge the supercapacitor, an electrical connection 305 is made between the charged electrodes 302, 303, causing electrons to flow from the anode to the cathode via the external circuit (as indicated by the arrows 304). This flow of charge can be used to power one or more electrical components 306 in the external circuit 305.

Supercapacitors have several advantages over batteries, and as a result, have been tipped to replace batteries in many applications. They function by supplying large bursts of current to power a device and then quickly recharging themselves. Their low internal resistance, or equivalent series resistance (ESR), permits them to deliver and absorb these large currents, whereas the higher internal resistance of a traditional chemical battery may cause the battery voltage to collapse. Also, whilst a battery generally demands a long recharging period, supercapacitors can recharge very quickly, usually within a matter of minutes. They also retain their ability to hold a charge much longer than batteries, even after multiple chargings. When combined with a battery, a supercapacitor can remove the instantaneous energy demands that would normally be placed on the battery, thereby lengthening the battery lifetime.

Whereas batteries often require maintenance and can only function well within a small temperature range, supercapacitors are maintenance-free and perform well over a broad temperature range. Supercapacitors also have longer lives than batteries, and are built to last until at least the lifetime of the electronic devices they are used to power. Batteries, on the other hand, typically need to be replaced several times during the lifetime of a device.

Supercapacitors are not without their drawbacks, however. Despite being able to store a greater amount of energy than conventional and electrolytic capacitors, the energy stored by a supercapacitor per unit weight is considerably lower than that of an electrochemical battery. In addition, the working voltage of a supercapacitor is limited by the electrolyte breakdown voltage, which is not as issue with batteries.

Lithium-ion batteries have the highest energy density of all systems, whilst supercapacitors have the highest power density and lifetime. Recently, a new hybrid storage device called a lithium-ion capacitor has been developed which aims to integrate the advantages of lithium-ion batteries and supercapacitors. The cathode of a lithium-ion capacitor employs activated carbon at which charges are stored as an electric double layer at the interface between the carbon and the electrolyte, similar to a supercapacitor. The anode, on the other hand, is made of a nanostructured intercalation material pre-doped with lithium ions, similar to a lithium-ion battery. This pre-doping process lowers the anode potential and results in a high cell output voltage. Typically, output voltages for lithium-ion capacitors are in the range of 3.8V to 4V. As a consequence, lithium-ion capacitors have a high energy density. Furthermore, the capacity of the anode is several orders of magnitude greater than the capacity of the cathode. As a result, the change in anode potential during charging and discharging is far smaller than the change in cathode potential. The intercalation anode can also be coupled with an intercalation cathode, such as LiCoO₂ or LiMn₂O₄, to increase the power of the lithium-ion capacitor. The electrolyte used in a lithium-ion capacitor is typically a lithium-ion salt solution, and a separator may be used to prevent direct physical contact between the anode and cathode.

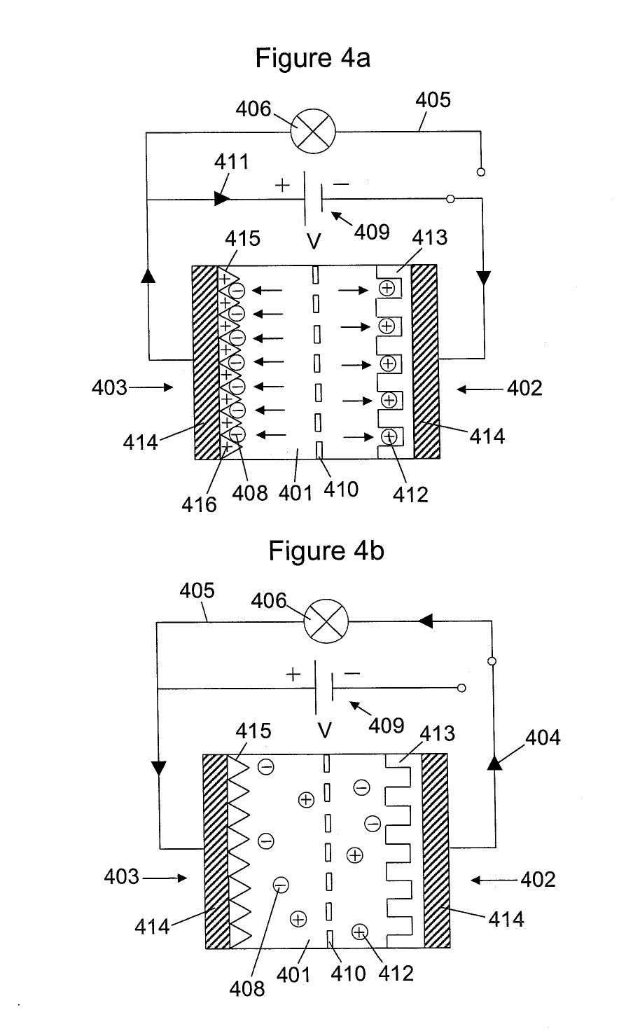

FIGS. 4a and 4b illustrate schematically the charging and discharge processes of a lithium-ion capacitor, respectively. The behaviour of a lithium-ion capacitor is much the same as that of a supercapacitor, and therefore the reference numerals of FIGS. 4a and 4b correspond to similar features in FIGS. 3a and 3b. The main difference between the two systems, however, is that instead of positive ions in the electrolyte 401 arranging themselves at the electrode-electrolyte interface to form an electric double layer when the device charges, lithium ions 412 insert themselves (intercalation) into the crystal structure 413 of the anode 402. Like a lithium-ion battery, therefore, lithium-ion capacitors undergo fast electrochemical reactions and do not simply rely on the formation of an electric double layer to store electrical charge.

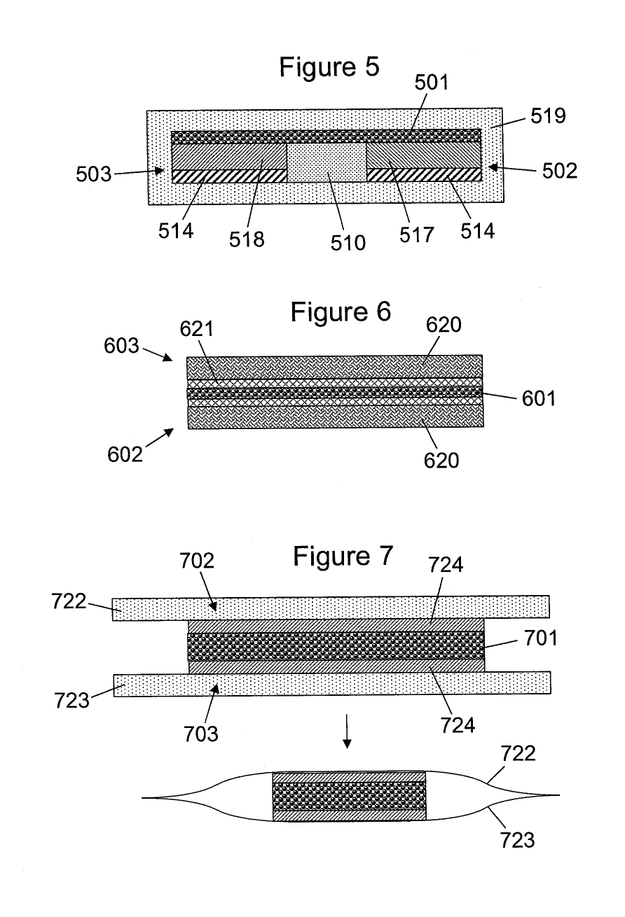

As mentioned in the background section, currently available storage cells are unable to satisfy the physical requirements of wearable electronics because the materials used to form these cells are insufficiently flexible and stretchable. Some recent attempts have been made to address this issue, but the resulting devices (illustrated in FIGS. 5 and 6) suffer from additional drawbacks.

FIG. 5 shows a Zn/MnO₂ battery embedded in an elastomer. The anode 502 and cathode 503 of this device comprise a MnO₂ 517 and zinc 518 paste, respectively, each deposited on a charge collector 514 made from a carbon paste. To prevent intermixing of the anode and cathode materials, the electrodes 502, 503 are positioned adjacent one another on the underlying elastomer 519 (rather than one on top of the other), physically separated by an elastomeric separator 510. The electrical circuit is completed by an electrolyte gel 501 which is positioned on top of the anode 502, cathode 503 and separator 510 as shown. By forming the electrodes 502, 503 as pastes and sealing the device with the elastomer 519, the battery is able to tolerate some degree of stretching and bending. However, because the anode 502 and cathode 503 lie in the same plane with the electrolyte 501 deposited on top, the device exhibits a large internal resistance. In addition, the device thickness is 2 mm, which is too large for wearable electronics.

FIG. 6 shows a stretchable supercapacitor. In this device, the electrodes 602, 603 are formed from textile fibres 620 coated with a carbon nanotube ink, and are separated from one another by a textile fibre 621 soaked in a liquid electrolyte 601. The conductive textile fibres 620 have been shown to provide the levels of flexibility and stretchability required by wearable electronics, but the device exhibits a large equivalent series resistance (ESR). In addition, no packaging is provided to prevent evaporation of the electrolyte 601 and degradation of the electrode materials with the external environment.

There will now be described an apparatus and associated methods that may provide a solution to the above-mentioned problems.

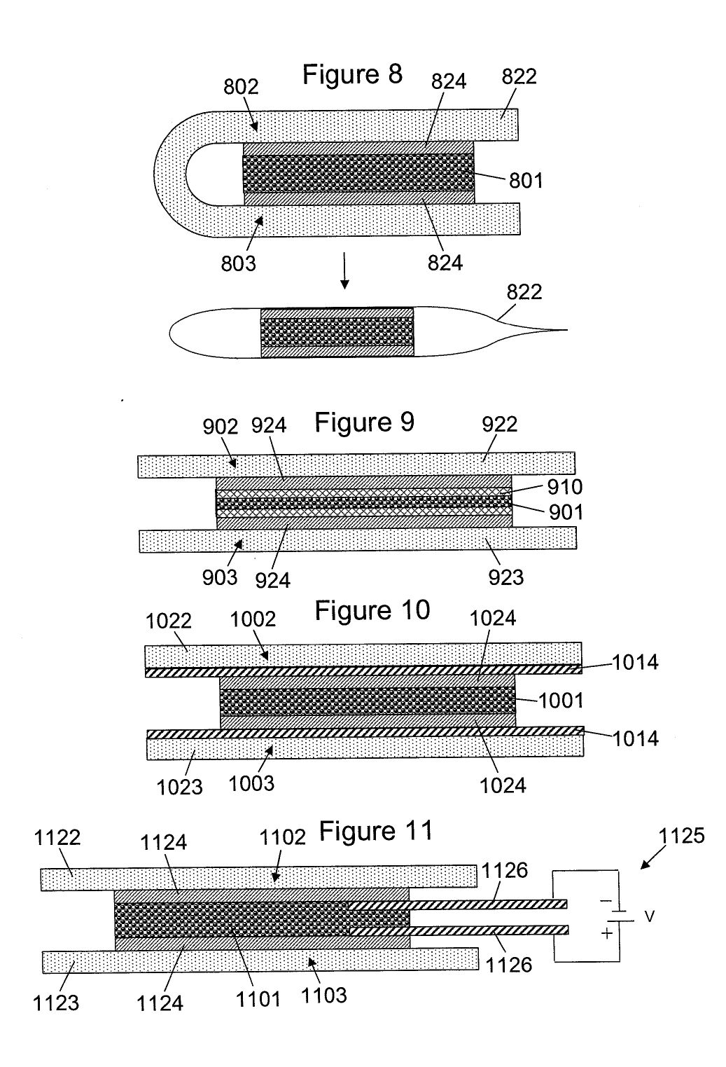

FIGS. 7 and 8 show an electrical storage apparatus in which the electrodes 702, 703, 802, 803 are supported on a stretchable substrate 722, 723, 822 which itself is used to form a sealed chamber as packaging for the cell. In FIG. 7, the first 702 and second 703 electrodes (anode 702 and cathode 703) are supported on respective substrates 722, 723 which are subsequently joined together to form the sealed chamber, whilst in FIG. 8, the first 802 and second 803 electrodes are supported on the same substrate 822 which is bent around onto itself (and joined) to form the sealed chamber. The electrical storage apparatus also comprises an electrolyte 701, 801 within the sealed chamber in the space between the first 702; 802 and second 703, 803 electrodes. The sealed chamber prevents evaporation or leakage of the electrolyte 701, 801, and also prevents air from the external environment from entering the cell and degrading (e.g. via oxidation) the electrode materials. By using a reversibly stretchable material to package the cell, an electrical storage apparatus is produced which is suitable for use in wearable electronics. The sealing process is typically performed in vacuum so that, when the storage cell is subsequently exposed to atmospheric pressure, the electrodes 702, 703, 802, 803 are forced together.

For use in a stretchable storage cell, the substrate 722, 723, 822 should be able to undergo repeated tensile strain of up to 50% in the plane of the apparatus without damage. It should also be able to form an airtight seal. A number of thermoplastic elastomers have been found which satisfy these requirements. Thermoplastic elastomers are a class of polymers that exhibit properties of both thermoplastic polymers and elastomeric polymers. Unlike thermosetting polymers, thermoplastic polymers can be melted and remoulded. This property allows the substrate 722, 723, 822 to form a heat-sealed chamber. Elastomeric polymers, on the other hand, exhibit elasticity, and generally have a notably low Young's modulus and high yield strain. This property allows the substrate 722, 723, 822 to be reversibly stretched.

Examples of suitable thermoplastic elastomers include thermoplastic urethane (polyester-based, polyether-based, or polycapa-based); a styrene-based thermoplastic elastomer (e.g. styrene-ethylene-butadiene-styrene (SEBS), styrene-butadiene-styrene (SBS), styrene-isoprene-styrene (SIS), or styrene-ethylene-propylene-styrene (SEPS)); a polyamide-based thermoplastic elastomer (e.g. ester-ether-amide (PEEA), ester-amide (PEA), carbonate-ester-amide (PCEA), or ether-block-amide (PEBA)); a polyester-based thermoplastic elastomer (e.g. ester-ether (PEE)); a polyolefin-based thermoplastic elastomer (e.g. polypropylene or ethylene and vulcanised rubber (PP+EPDM), or polypropylene or ethylene and vulcanised/non-vulcanised rubber); a polymeric organosilicon (e.g. polydimethylsiloxane (PDMS)); a fluoropolymer (e.g. polytetrafluoroethylene (PTFE)); and a thermoplastic urethane with dynamically vulcanised silicone.

Each electrode 702, 703, 802, 803 of the electrical storage apparatus comprises an active material 724, 824 which takes part in the charging/discharging mechanism of the apparatus. In a battery, for example, the active material 724, 824 is the electrode material that participates in the electrochemical reaction or intercalation mechanism. In a supercapacitor, on the other hand, the active material 724, 824 is the electrode material which participates in the formation of the electric double layer. In order for the electrical storage apparatus to be reversibly stretched, the active material 724, 824 of the first 702, 802 and second 703, 803 electrodes (which is supported by the substrate 722, 723, 822) should also be reversibly stretchable.

Research has shown that a layer of substantially horizontally-aligned carbon nanotubes (single or multi-walled carbon nanotubes) deposited on top of a thermoplastic elastomer substrate is able to tolerate more than 100% tensile strain with only a modest reduction in electrical conductivity. As a result, a carbon nanotube layer may serve as the active material 724, 824 itself, or it could serve as a stretchable high surface area support for another active material 724, 824 (such carbon nanoparticles, graphene platelets, metal oxide nanoparticles, or any of the electrode materials mentioned with reference to FIGS. 1-4). In the latter scenario, the carbon nanotube layer may also act as a charge collector for the electrical storage apparatus. The ability of a carbon nanotube layer to undergo reversible stretching whilst still maintaining good electrical conductivity is due to the alignment of the nanotubes. When the nanotubes are first deposited on the substrate (as will be described later), the nanotubes do not lie perfectly flat or parallel to one another (e.g. they may be aligned at an angle of 0°-20° with respect to the plane of the substrate, and at an angle of 0°-20° with respect to one another). As the layer is increasingly strained, however, the nanotubes become more aligned with one another. During this alignment process, the individual nanotubes experience negligible strain. It is not until the nanotubes are completely aligned that the structure of the nanotube layer begins to deteriorate with further stress. At this stage, adjacent nanotubes (along the strain axis) begin to move apart, and individual nanotubes start to undergo nanoscopic strain. Both effects result in a reduction in the electrical conductivity and may also cause irreversible damage to the layer.

A similar result may be achieved using metal or semiconductor nanowires instead of carbon nanotubes, or by using a carbon, metal or semiconductor nanotube/nanowire network or mesh. As with the carbon nanotube layer, these materials may also be used as a stretchable high surface area support for another active material 724, 824, and/or as a charge collector.

In FIGS. 7 and 8, the electrolyte 701, 801 is in the form of a gel rather than a liquid. An advantage of using a gel electrolyte is that, depending on the viscosity of the gel, a separator (typically used to prevent physical contact between the anode 702, 802 and cathode 703, 803 and therefore electrical shorting) may not be necessary. FIG. 9, on the other hand, shows an electrical storage apparatus comprising a liquid electrolyte 901 contained within an absorbent separator 910. For stretchable storage cells, it is important that the separator 910 (or gel electrolyte 901) is also reversibly stretchable. The electrolyte 901 will depend on the specific chemistry of the cell, but suitable separators 910 include textiles such as cotton, polyester or lycra, and porous elastomer membranes made from fluoroelastomers, polyester elastomers or hydrocarbon elastomers.

FIG. 10 shows a stretchable storage cell comprising a layer of charge collection material 1014 between the active electrode material 1024 and the substrate 1022, 1023. The charge collection material 1014 enables the transfer of electrons to and from the active material 1024 during the charging and discharging operations. As with the other components of a stretchable storage cell, any charge collection material 1014 should also be reversibly stretchable. In this respect, suitable materials include an electrically conductive textile (e.g. electrolycra), a layer of metal (e.g. a layer gold, aluminium, copper and/or silver), a layer of metal meanders (e.g. a layer comprising an array of gold, aluminium, copper and/or silver meanders), or a plurality of metal particles (e.g. gold, aluminium, copper and/or silver particles). If a plurality of metal particles are used, these may be deposited on top of the substrate 1022, 1023 (i.e. between the substrate 1022, 1023 and the active material 1024) or dispersed with the substrate material 1022, 1023 (i.e. to form a composite).

To enable the transfer of electrons between each electrode 1102, 1103 and the external circuit 1125 (e.g. to enable charging and discharging of the cell and the powering of other components), the stretchable storage cell may also comprise an electrical connector 1126 (contact) at the first 1102 and second 1103 electrodes, as shown in FIG. 11. In the illustrated example, the electrical connector 1126 is positioned on top the active material 1124 (i.e. between the active material 1124 and the electrolyte 1101), but in practice could be positioned between the substrate 1122, 1123 and the active material 1124, between the substrate 1122, 1123 and the charge collection material 1114 (not shown), between the active material 1124 and the charge collection material 1114 (not shown), or even as an electrically conductive layer of the substrate 1122, 1123 (e.g. if the substrate 1122, 1123 is a stretchable printed wiring board). In the latter case, the electrically conductive layer should be electrically connected to the active material 1124 and/or charge collection material 1114 (e.g. using vertical interconnect access (VIA) connections). One reason for not positioning the electrical connector 1126 between the active material 1124 and the electrolyte 1101 is that it may reduce the effective area of the electrode 1102, 1103 by physically hindering the interaction between electrolyte ions and the active material 1124.

The electrical connector 1126 should also be reversibly stretchable. Examples of possible connectors 1126 which could provide this functionality include metal tapes or metal meanders (e.g. gold, aluminium, copper and/or silver tapes or meanders).

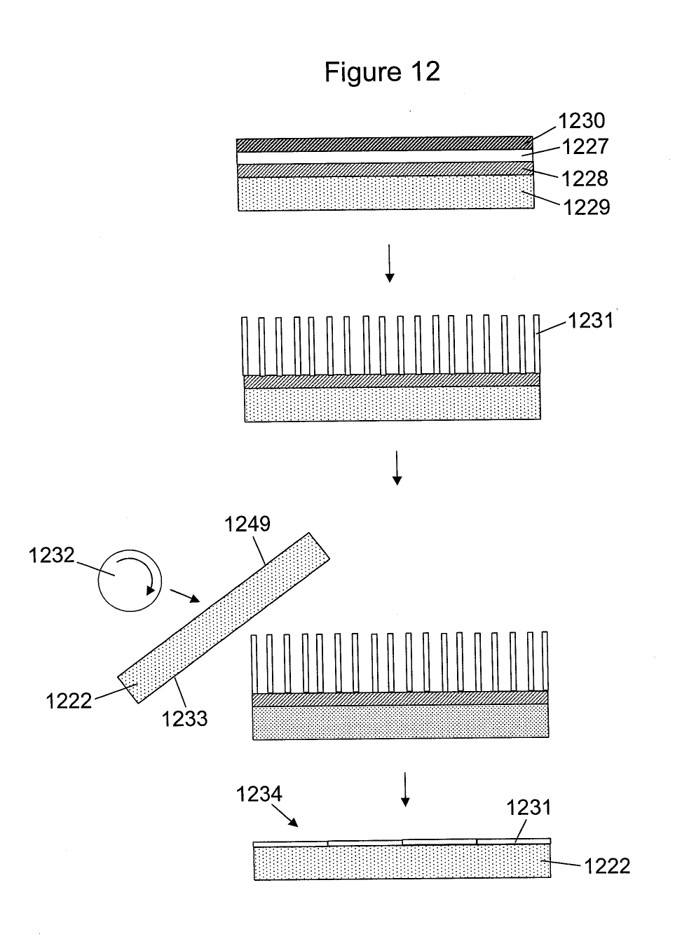

As mentioned previously, a useful active material for the first and second electrodes is layer of substantially horizontally-aligned carbon nanotubes. FIG. 12 illustrates one method which may be used to form such a layer. First, a bilayer catalyst is prepared by RF sputtering 10 nm Al₂Oₓ 1227 onto a 200 nm thermally oxidised 1228 Si substrate 1229 (the growth substrate), followed by thermal evaporation of a 1 nm Fe layer 1230 at a deposition rate of 0.2 Å/s. The coated substrate 1229 is then loaded into a thermal chemical vapour deposition (CVD) reactor, and the chamber is pressurised to 26 mbar using 8 sccm C₂H₂ diluted with 192 sccm H₂. The ohmically-heated graphite stage is then ramped at 5° C./s to a growth temperature of 700° C. Carbon nanotube growth is typically initiated at ˜520° C. with a growth rate of ˜0.8 μm/s (which decreases monotonically over time). The resulting substrate 1229 comprises an array of substantially vertical nanotubes 1231.

A dry transfer process is then used to transfer the nanotubes 1231 from the growth substrate 1229 to a reversibly stretchable substrate 1222. The process involves angling the stretchable substrate 1222 and bringing it into contact with the vertical nanotubes 1231 such that the nanotubes 1231 experience a horizontal component of force (without breakage). The stretchable substrate 1222 is then positioned flat on top of the growth substrate 1229 such that the nanotubes 1231 are lying substantially horizontal and sandwiched between the two substrates 1222, 1229. To encourage transfer of the nanotubes 1231 from the growth substrate 1229 to the stretchable substrate 1222, a quartz cylinder 1232 is then rolled across the upper surface 1249 of the stretchable substrate 1222 to compress the underlying nanotubes 1231. Given the deformable nature of the stretchable substrate 1222, the lower surface 1233 of the substrate 1222 accommodates the (more rigid) nanotubes 1231. When the growth 1229 and stretchable substrates 1222 are pulled apart, the nanotubes 1231 de-anchor from the growth substrate 1229 and adhere to the stretchable substrate 1222. In some cases (depending on the specific substrate material), the stretchable substrate 1222 may need to be heated to provide improved adhesion to the nanotubes 1231. Another option is to pre-deposit an adhesion promoter (such as poly(lysine) or aminopropyltriethoxy silane) onto the lower surface 1233 of the stretchable substrate 1222. The resulting substrate 1222 comprises a layer 1234 of substantially horizontally-aligned carbon nanotubes 1231.

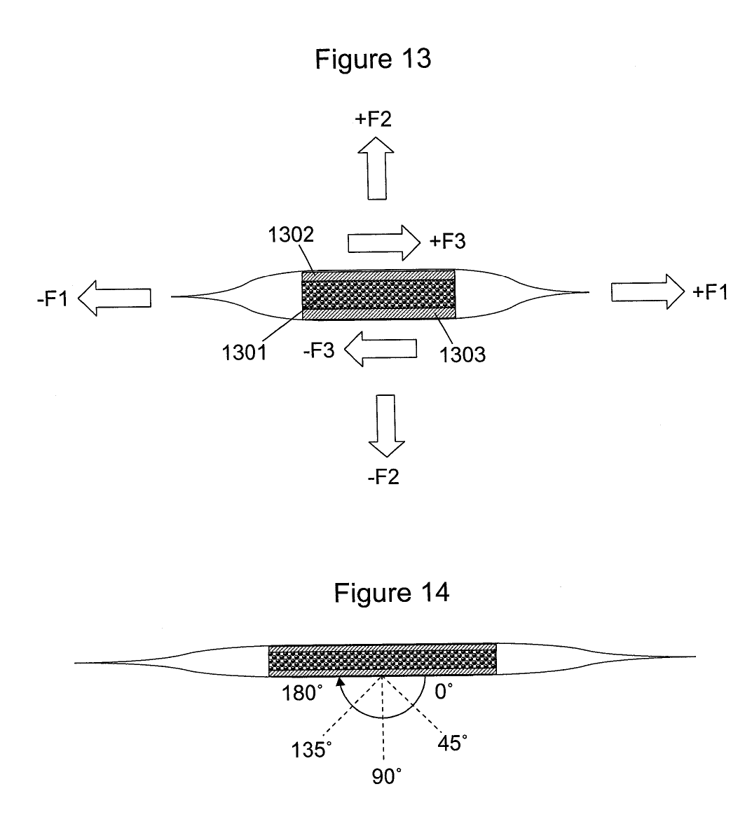

The arrows in FIG. 13 illustrate the directions of force that might be applied to the storage cell to induce tensile strain. When forces F1 and −F1 are applied, the storage cell undergoes reversible stretching in the plane of the cell (assuming the apparatus has a generally planar form). This has the effect of reducing the thickness of the apparatus (see FIG. 14). On the other hand, when forces F2 and −F2 are applied, the storage cell undergoes reversible stretching perpendicular to the plane of the cell. This has the effect of increasing the thickness of the apparatus. In addition, when forces F3 and −F3 are applied, the storage cell undergoes shearing strain. In this scenario, the first 1302 and second 1303 electrodes may move laterally (i.e. parallel to the plane of the cell) with respect to one another. Nevertheless, provided the electrodes 1302, 1303 remain in contact with the electrolyte 1301, relative lateral movement of the electrodes 1302, 1303 should not adversely affect operation of the device.

As well as undergoing reversible stretching, the apparatus may be configured to undergo reversible bending (flexing). The extent to which the storage cell can be bent will depend on the number and flexibility of the various constituent layers. In some cases, the apparatus may be bent to an angle (bending angle) of 45°, 90°, 135° or 180° with respect to the plane of the cell.

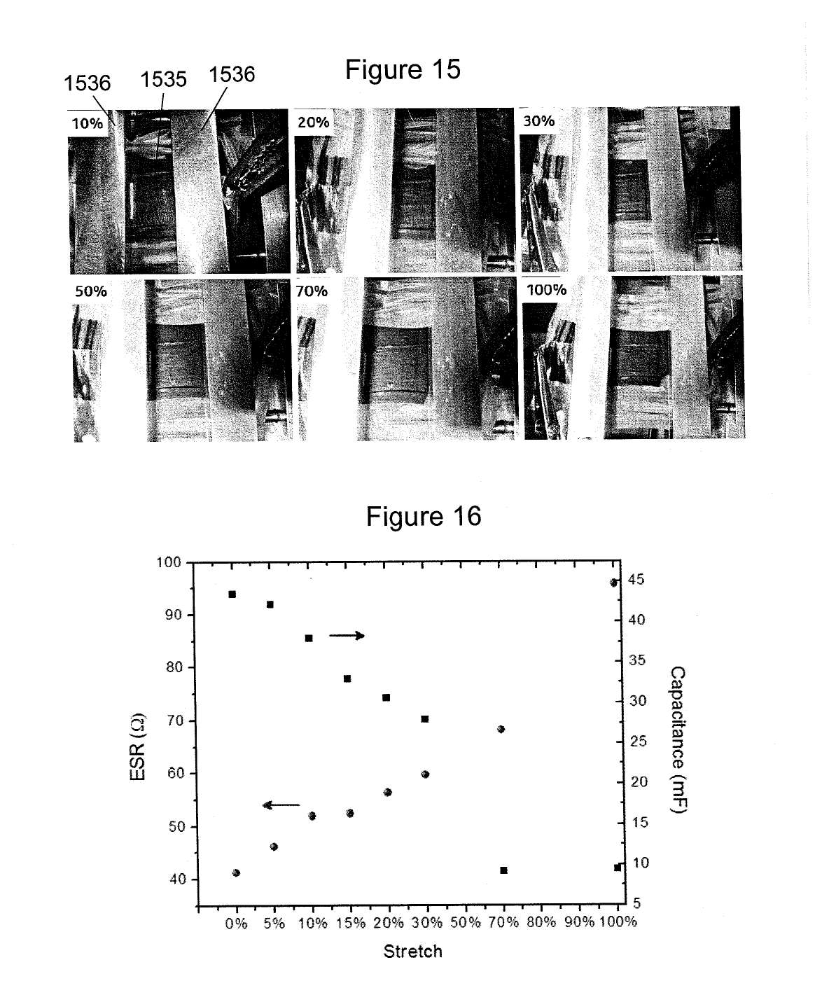

FIG. 15 shows a stretchable supercapacitor 1535 at various degrees of tensile strain (parallel to the plane of the apparatus), whilst FIG. 16 shows corresponding ESR and capacitance measurements. The supercapacitor 1535 can be seen in the photographs between the clamps 1536 of the measuring rig. The supercapacitor 1535 comprises a polyurethane substrate (50 μm thick), first and second electrodes comprising a layer of horizontally-aligned carbon nanotubes (500 μm long), a KCl electrolyte contained within a lycra separator, and copper tape between the carbon nanotubes and the separator to connect the electrodes to the external circuit. The structure was heat-sealed at ˜120° to weld the polyurethane together.

The supercapacitor showed good electrical response (high capacitance, low ESR) at all strain values and was functional up to 100% strain. The capacitance did, however, decrease significantly above 50% strain, rendering the recommended operating regime in the 0-50% range. The ESR of the device increased linearly with strain, which is expected due to the reduction in conductivity of the carbon nanotube layer. When the tensile strain was subsequently reduced to 0%, the initial performance (i.e. the electrical response at 0% strain before stretching) was fully recovered.

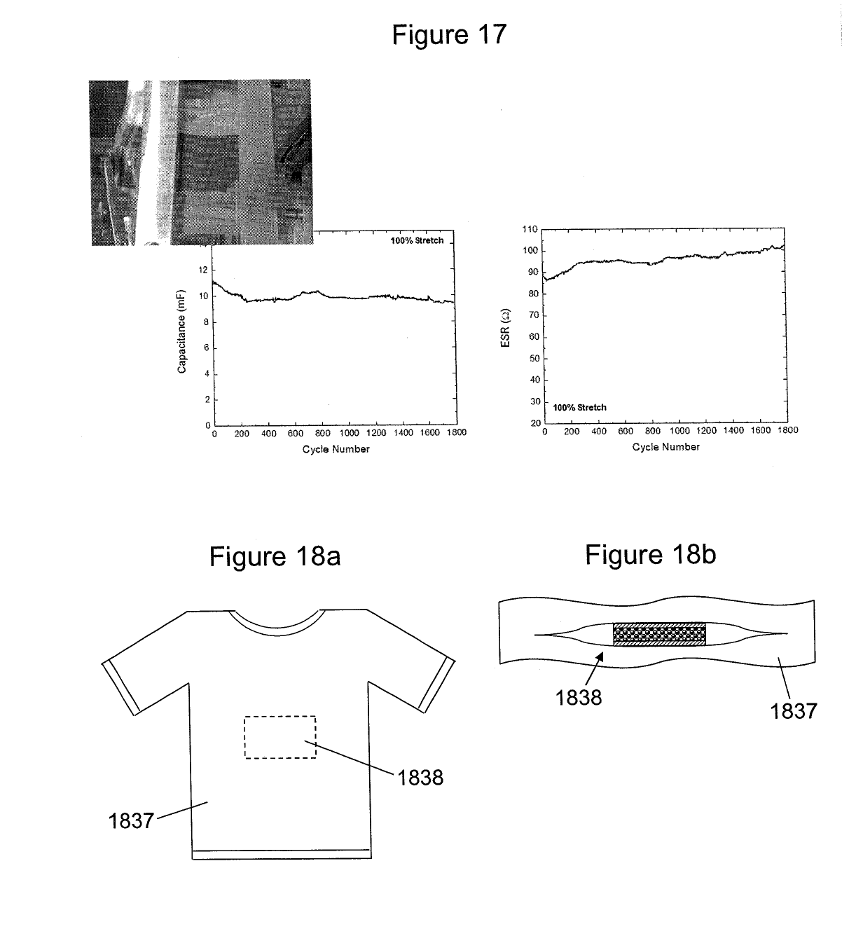

To test the durability of the device, the supercapacitor was then stretched to 100% strain and the electrical behaviour monitored over 1800 charge/discharge cycles. The variation in capacitance and ESR with cycle number is shown in FIG. 17. As can be seen from these graphs, the electrical response was fairly constant throughout the course of the experiment (the capacitance decreased by ˜18% and the ESR increase by ˜18%). It was found, however, that the reduction in performance was the result of mechanical failure of the lycra separator rather than the active material, which leaves much scope for improvement. The measured ESR for this device is greater than that of state of the art bulk supercapacitors. Nevertheless, this value may be significantly reduced by incorporating charge collection materials (discussed previously) in the structure.

The whole concept of wearable electronics is that fully-functioning electronic components and devices can be integrated within items of clothing with minimal impact on the flexibility and stretchability of the textile. The stretchable storage cells described herein may be able to satisfy this requirement. FIG. 18a shows a t-shirt 1837 comprising the storage cell 1838, whilst FIG. 18b shows a cross-sectional view of the storage cell 1838 embedded within the t-shirt material 1837 (which may be cotton, polyester, lycra, etc). The storage cell may be embedded within, or attached to, the material by gluing, thermally attaching, or sewing the storage cell to the material.

As well as wearable electronics, the present apparatus may also find use in modern electronic devices in general. In modern devices, miniaturisation is an important factor, and state-of-the-art batteries and supercapacitors do not adequately fulfil the size requirements. The stretchable storage cells described herein may provide a solution to this problem. Flex-to-install and dynamic flex circuit boards are becoming more commonplace. Flex-to-install refers to a circuit board (e.g. a flexible printed circuit (FPC) board) which is bent or folded during device assembly, but which undergoes minimal flexing during the lifetime of the device. If the circuit board is sufficiently durable, however, it may also be suitable for dynamic flex applications in which the circuit board is required to bend both during and after device assembly. Stretchable devices may also require circuit boards which can undergo stretching during and/or after device assembly (i.e. stretch-to-install and/or dynamic stretch applications). The present apparatus may allow this concept to be extended to the storage cells of the device, which may be bent or stretched in order to fit inside the smallest of device casings. The stretchable storage cells may even be attached to the FPC boards.

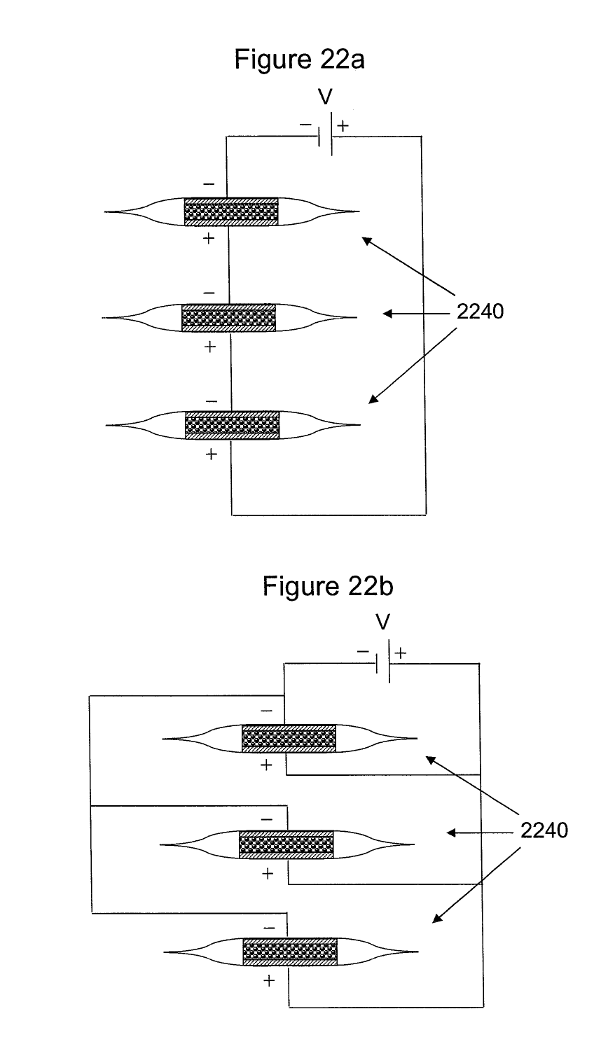

Given that batteries and capacitors are used to power other electronic components in a device, the electrical characteristics (e.g. operating current, voltage, resistance, capacitance, etc) of the battery/capacitor are an important consideration. In general, the maximum operating voltage of a supercapacitor is limited by the breakdown voltage of the electrolyte (˜1.1V for aqueous electrolytes and ˜2.3V for organic electrolytes), whilst the maximum operating voltage of a battery is limited by the active materials used in the electrochemical reactions. In order to increase the operating voltage of a storage cell 2240 (battery or capacitor), several cells 2240 may be connected in series (e.g. as a stack of storage cells 2240), as shown in FIG. 22a. The total voltage for three storage cells connected in series is given by Vₜₒₜₐₗ=V₁+V₂+V₃, where Vₙ is the operating voltages of the respective cells. When connected in series, the total current is given by Iₜₒₜₐₗ=I₁+I₂+I₃, the total resistance is given by Rₜₒₜₐₗ=R₁+R₂+R₃, and the total capacitance (relevant for supercapacitors) is given by Cₜₒₜₐₗ=1/C₁+1/C₂+1/C₃, where Iₙ, Rₙ and Cₙ are the operating current, resistance and capacitance of the respective cells.

On the other hand, several cells 2240 could be connected in parallel (e.g. as a stack of storage cells 2240), as shown in FIG. 22b. In this configuration, the total voltage is given by Vₜₒₜₐₗ=V₁+V₂+V₃, the total current is given by Iₜₒₜₐₗ=I₁+I₂+I₃, the total resistance is given by Rₜₒₜₐₗ=1/R₁+1/R₂+1/R₃, and the total capacitance (relevant for supercapacitors) is given by Cₜₒₜₐₗ=C₁+C₂+C₃.

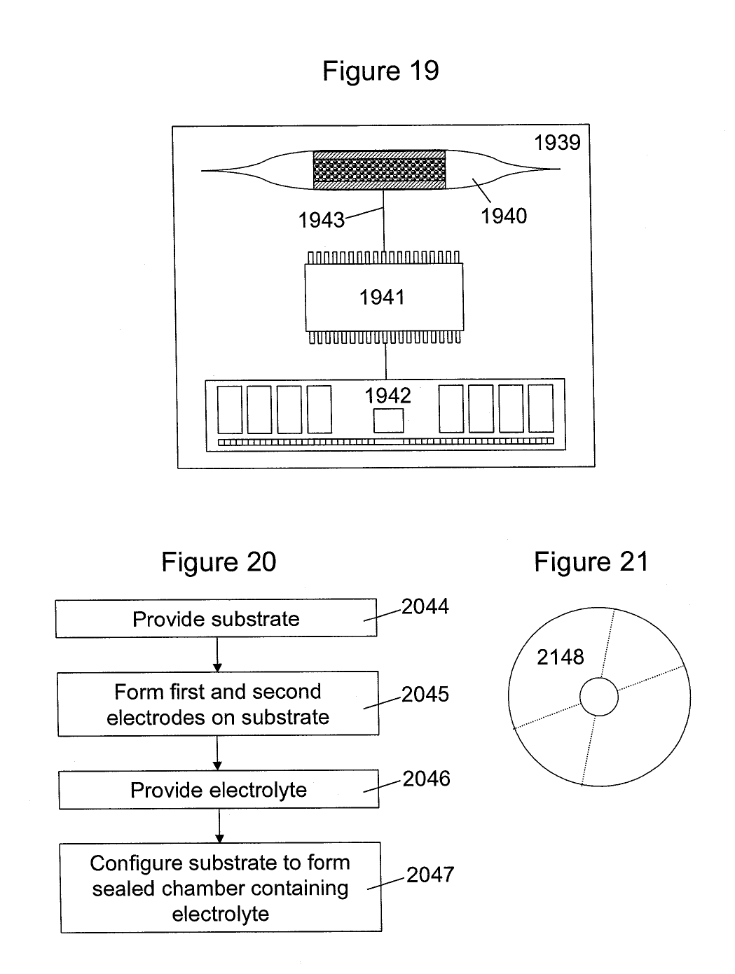

FIG. 19 illustrates schematically a device 1939 comprising the electrical storage apparatus 1940 described herein. The device 1939 also comprises a processor 1941 and a storage medium 1942, which are electrically connected to one another by a data bus 1943. The device 1939 may be an electronic device, a portable electronic device, a portable telecommunications device, or a module for any of the aforementioned devices.

The electrical storage apparatus 1940 is configured to generate and/or store electrical energy, which may be used to power one or more components of the device 1939. The electrical storage apparatus 1940 is configured to undergo reversible stretching (and possibly reversible flexing), and may be attached to an FPC board of the device 1939.

The processor 1941 is configured for general operation of the device 1939 by providing signalling to, and receiving signalling from, the other device components to manage their operation.

The storage medium 1942 is configured to store computer code configured to perform, control or enable operation of the electrical storage apparatus 1940. The storage medium 1942 may also be configured to store settings for the other device components. The processor 1941 may access the storage medium 1942 to retrieve the component settings in order to manage the operation of the device components. In particular, the storage medium 1942 may comprise voltage settings for charging the electrical storage apparatus 1940. The storage medium 1942 may be a temporary storage medium such as a volatile random access memory. On the other hand, the storage medium 1942 may be a permanent storage medium such as a hard disk drive, a flash memory, or a non-volatile random access memory.

The main steps 2044-2047 of the method used to make the electrical storage apparatus 1940 are illustrated schematically in FIG. 20.

FIG. 21 illustrates schematically a computer/processor readable medium 2148 providing a computer program according to one embodiment. In this example, the computer/processor readable medium 2148 is a disc such as a digital versatile disc (DVD) or a compact disc (CD). In other embodiments, the computer/processor readable medium 2148 may be any medium that has been programmed in such a way as to carry out an inventive function. The computer/processor readable medium 2148 may be a removable memory device such as a memory stick or memory card (SD, mini SD or micro SD).

The computer program may comprise computer code configured to perform, control or enable one or more of the following: providing at least one substrate; forming first and second electrodes on the at least one substrate; providing an electrolyte; and configuring the at least one substrate to form a sealed chamber with the first and second electrodes contained therein and facing one another, the sealed chamber comprising the electrolyte in the space between the first and second electrodes, wherein the at least one substrate is configured to undergo reversible stretching whilst still forming the sealed chamber containing the electrolyte.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising at least one substrate, the at least one substrate comprising first and second electrodes and configured to form a sealed chamber with the first and second electrodes contained therein and facing one another, the sealed chamber comprising electrolyte in the space between the first and second electrodes, wherein the at least one substrate is configured to undergo reversible stretching whilst still forming the sealed chamber containing the electrolyte.

2. The apparatus of claim 1, wherein the apparatus comprises first and second substrates, the first substrate comprising the first electrode and the second substrate comprising the second electrode, and wherein the first and second substrates are joined together to form the sealed chamber.

3. The apparatus of claim 2, wherein the first and/or second substrate is configured to undergo reversible stretching.

4. The apparatus of claim 1, wherein the apparatus comprises a first substrate, the first substrate comprising both the first and second electrodes, and wherein the first substrate is bent around onto itself to form the sealed chamber.

5. The apparatus of claim 1, wherein in an unstretched state, the apparatus has a generally planar form, and wherein the at least one substrate is configured to undergo reversible stretching substantially parallel to the plane of the apparatus.

6. The apparatus of claim 1, wherein the at least one substrate is configured to undergo reversible stretching of up to 100% tensile strain.

7. The apparatus of claim 1, wherein the at least one substrate comprises a thermoplastic elastomer.

8. The apparatus of claim 7, wherein the thermoplastic elastomer comprises one or more of a thermoplastic urethane (polyester-based, polyether-based, or polycapa-based); a styrene-based thermoplastic elastomer (e.g. styrene-ethylene-butadiene-styrene (SEBS), styrene-butadiene-styrene (SBS), styrene-isoprene-styrene (SIS), or styrene-ethylene-propylene-styrene (SEPS)); a polyamide-based thermoplastic elastomer (e.g. ester-ether-amide (PEEA), ester-amide (PEA), carbonate-ester-amide (PCEA), or ether-block-amide (PEBA)); a polyester-based thermoplastic elastomer (e.g. ester-ether (PEE)); a polyolefin-based thermoplastic elastomer (e.g. polypropylene or ethylene and vulcanised rubber (PP+EPDM), or polypropylene or ethylene and vulcanised/non-vulcanised rubber); a polymeric organosilicon (e.g. polydimethylsiloxane (PDMS)); a fluoropolymer (e.g. polytetrafluoroethylene (PTFE)); and a thermoplastic urethane with dynamically vulcanised silicone.

9. The apparatus of claim 1, wherein the first and/or second electrode comprises an active material.

10. The apparatus of claim 9, wherein the active material is configured to undergo reversible stretching.

11. The apparatus of claim 9, wherein the active material comprises one or more of the following: carbon nanoparticles, carbon nanotubes, carbon nanohorns, a carbon nanotube network, graphene, graphene platelets, metal nanowires, a metal nanowire mesh, semiconductor nanowires, a semiconductor nanowire mesh, and metal oxide nanoparticles.

12. The apparatus of claim 1, wherein the first and/or second electrode comprises a charge collection material.

13. The apparatus of claim 12, wherein the charge collection material comprises one or more of an electrically conductive textile, a layer of metal, a layer of metal meanders, and a plurality of metal particles.

14. The apparatus of claim 1, wherein the apparatus comprises a separator between the first and second electrodes.

15. The apparatus of claim 14, wherein the separator comprises one of more of the following: cotton, polyester, lycra, a fluoroelastomer, a polyester elastomer, and a hydrocarbon elastomer.

16. The apparatus of claim 1, wherein the electrolyte comprises propylene carbonate or an aqueous solution of potassium chloride.

17. The apparatus of claim 1, wherein the at least one substrate is configured to undergo reversible bending.

18. The apparatus of claim 17, wherein the at least one substrate is configured to undergo reversible bending to an angle of 180°.

19. The apparatus of claim 1, wherein the apparatus is at least one of the following: a battery, a capacitor, and a battery-capacitor hybrid.

20. A device comprising the apparatus of claim 1.

21. The device of claim 20, wherein the device is at least one of the following: an electronic device, a portable electronic device, a portable telecommunications device, and a module for any of the aforementioned devices.

22. A textile comprising the apparatus of claim 1.

23. The textile of claim 22, wherein the textile forms part of an item of clothing.

24. A method of making an apparatus, the method comprising:
providing at least one substrate;
forming first and second electrodes on the at least one substrate;
providing an electrolyte; and
configuring the at least one substrate to form a sealed chamber with the first and second electrodes contained therein and facing one another, the sealed chamber comprising the electrolyte in the space between the first and second electrodes, wherein the at least one substrate is configured to undergo reversible stretching whilst still forming the sealed chamber containing the electrolyte.
